(19) United States
(12) Patent Application Publication
(10) Pub. No.: US 2025/0158863 A1
(43) Pub. Date: May 15, 2025

(54) WIRELESS COMMUNICATION METHOD AND APPARATUS

(71) Applicant: LENOVO (BEIJING) LIMITED, BEIJING (CN)

(72) Inventors: HONGMEI LIU, BEIJING (CN); ZHI YAN, BEIJING (CN); YUANTAO ZHANG, BEIJING (CN); YINGYING LI, BEIJING (CN); HAIMING WANG, BEIJING (CN)

(21) Appl. No.: 18/728,425

(22) PCT Filed: Jan. 11, 2022
(86) PCT No.: PCT/CN2022/071308

§ 371 Date: Jul. 11, 2024

(51) Int. Cl. H04L 27/26; H04W 72/044; H04W 74/0833

(52) U.S. Cl. CPC H04L 27/261; H04W 72/046; H04W 74/0833

(57) ABSTRACT

Embodiments of the present application are related to a wireless communication method and apparatus. According an embodiment of the present application, an exemplary method performed by a user equipment (UE) includes: receiving, at the UE, a signaling indicating at least one reference signal (RS), where a spatial domain filter associated with the at least one RS is on or off; and determining at least one of a random access procedure or a paging procedure based on the signaling.

### TECHNICAL FIELD

Embodiments of the present application generally relate to wireless communication technologies, and especially to a wireless communication method and apparatus for data transmission.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

To improve network energy savings in terms of both base station (BS) transmission and reception, techniques are studied and identified on the BS side and user equipment (UE) side. For example, according to RP-212669, the focus areas include how to achieve more efficient dynamic and/or semi-static and finer granularity adaptation of transmissions and/or receptions in one or more of time, frequency, spatial, and power domains, with potential support/feedback from UE. Additional areas of the study may include UE assistance information and intra-network information exchange/coordination. In addition, RP-212669 also provides that legacy UEs should be able to continue accessing a network implementing Rel-14 network energy savings techniques, with the possible exception of techniques developed specifically for greenfield deployments.

Thus, it is desirable to improve technical solutions for data transmission, especially considering saving energy in BS side and UE side as required, to adapt to the industry trend.

### SUMMARY OF THE DISCLOSURE

One objective of the present application is to provide a wireless transmission method and apparatus, which can at least save energy in the BS side and UE side.

According to some embodiments of the present application, an exemplary apparatus, e.g., a remote apparatus includes: at least one receiving circuitry; at least one transmitting circuitry: and at least one processor coupled to the at least one receiving circuitry and the at least one transmitting circuitry. The at least one processor is configured to: receive, via the at least one receiving circuitry, a signaling indicating at least one reference signal (RS), wherein a spatial domain filter associated with the at least one RS is on or off; and determine at least one of a random access procedure or a paging procedure based on the signaling.

According to some other embodiments of the present application, an exemplary apparatus, e.g., a radio access network (RAN) node includes: at least one receiving circuitry: at least one transmitting circuitry: and at least one processor coupled to the at least one receiving circuitry and the at least one transmitting circuitry. The at least one processor is configured to: transmit, via the at least one transmitting circuitry, a signaling indicating at least one RS, wherein a spatial domain filter associated with the at least one RS is on or off; and determine at least one of a random access procedure or a paging procedure based on the signaling.

In some embodiments of the present application, determining a random access procedure based on the signaling includes: not using the spatial domain filter, not using a physical uplink shared channel (PUSCH) occasion associated with the spatial domain filter, or not using a physical random access channel (PRACH) occasion (RO) associated with the spatial domain filter for the random access procedure in the case of the spatial domain filter being off.

In some embodiments of the present application, determining a random access procedure based on the signaling includes: at least one of PUSCH occasion or RO associated with the spatial domain filter is valid for the random access procedure in the case of the spatial domain filter being on.

In some embodiments of the present application, in the case that a RO associated with the spatial domain filter overlaps a downlink channel or a downlink RS in time domain, the at least one processor of the remote apparatus is configured to: receive the downlink channel or the downlink RS in the case of the spatial domain filter being off; or not receive the downlink channel or the downlink RS in the case of the spatial domain filter being on. In the case that a RO associated with the spatial domain filter overlaps a downlink channel or a downlink RS in time domain, the at least one processor of the RAN node is configured to: transmit the downlink channel or the downlink RS in the case of the spatial domain filter being off; or not transmit the downlink channel or the downlink RS in the case of the spatial domain filter being on.

In some embodiments of the present application, determining a random access procedure based on the signaling includes: synchronization signal (SS)/physical broadcast channel (PBCH) block (SSB) to RO association is updated for all or partial ROs based on a set of SSB whose associated spatial domain filter is on. For example, the SSB to RO association is updated for all or partial ROs at a start of at least one of an association period, a mapping cycle, or an association pattern period. The association period is an association period nearest to application of the signaling among a plurality of association periods later than the application of the signaling. The mapping cycle is a mapping cycle nearest to application of the signaling among a plurality of mapping cycles later than the application of the signaling. The association pattern period is an association pattern period nearest to application of the signaling among a plurality of association pattern periods later than the application of the signaling. In another example, the SSB to RO association is updated for partial ROs by updating the SSB to RO association for at least one SSB of the set of SSB. The at least one SSB is configured, or is determined, based on SSB index configuration in at least one of system information block (SIB) 1, radio resource control (RRC), media access control (MAC) control element (CE), or group common downlink control information (DCI). In yet another example, the SSB to RO association is updated for partial ROs by updating the SSB to RO association for at least one association period, or for at least one mapping cycle, or for at least one association pattern period. The at least one mapping cycle is configured, or is determined, based on SSB or based on PRACH periodicity and offset configuration or based on PUSCH periodicity and offset configuration.

In some embodiments of the present application, determining a random access procedure based on the signaling includes: in the case of the spatial domain filter being on, a RO, which does not precede an SSB in a PRACH slot and starts after a gap from a last SSB reception symbol based on an SSB associated with the spatial domain filter, is valid.

In some embodiments of the present application, determining a random access procedure based on the signaling includes: in the case of the spatial domain filter being on, a PUSCH occasion, which does not precede an SSB in a PUSCH slot and starts after a gap from a last SSB reception symbol based on an SSB associated with the spatial domain filter, is valid.

In some embodiments of the present application, determining a paging procedure based on the signaling includes: in the case of the spatial domain filter being on, a paging occasion (PO) is a set of “S*X” consecutive physical downlink control channel (PDCCH) monitoring occasions, where “X” is a number of PDCCH monitoring occasions per SSB in PO, and “S” is a number of SSBs associated with the spatial domain filter being on. In an example, an association of SSB with PDCCH monitoring occasion for paging is updated at a starting boundary of a nearest PO among a plurality of POs after application of the signaling. In another example, an association of SSB with PDCCH monitoring occasion for paging is updated at a time instance determined by a number of POs indicated in a paging early indication (PEI). In yet another example, an association of SSB with PDCCH monitoring occasion for paging is updated at a starting boundary of a nearest paging frame among a plurality of paging frames after application of the signaling. In yet another example, an association of SSB with PDCCH monitoring occasion for paging is updated at a starting boundary of a nearest discontinuous reception (DRX) cycle among a plurality of DRX cycles after application of the signaling.

In some embodiments of the present application, determining a paging procedure based on the signaling includes: in the case of the spatial domain filter being off, not monitoring PEI associated with the spatial domain filter being off in the remote apparatus, and not transmitting PEI associated with the spatial domain filter being off in the RAN node.

In addition, some embodiments of the present application provide a method, which includes: receiving a signaling indicating at least one RS, wherein a spatial domain filter associated with the at least one RS is on or off; and determining at least one of a random access procedure or a paging procedure based on the signaling.

Some embodiments of the present application provide another method, which includes: transmitting a signaling indicating at least one RS, wherein a spatial domain filter associated with the at least one RS is on or off; and determining at least one of a random access procedure or a paging procedure based on the signaling.

Given the above, embodiments of the present application provide a technical solution supporting dynamic beam on/off indication to save network energy, obviating the impact on the random access procedure, e.g., random access channel (RACH) procedure and paging procedure caused by the dynamic beam on/off indication, and thus will facilitate the deployment and implementation of NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application.

FIG. 2 is a flow chart illustrating an exemplary wireless communication method according to some embodiments of the present application.

FIG. 3 is a schematic diagram illustrating an exemplary procedure of updating SSB to RO association according to some embodiments of the present application.

FIG. 4 is a schematic diagram illustrating an exemplary procedure of updating SSB to RO association according to some other embodiments of the present application.

FIG. 5 is a schematic diagram illustrating an exemplary procedure of updating SSB to PDCCH monitoring occasion association according to some embodiments of the present application.

FIG. 6 is a schematic diagram illustrating an exemplary procedure of updating SSB to PDCCH monitoring occasion association according to some other embodiments of the present application.

FIG. 7 is a schematic diagram illustrating an exemplary procedure of updating SSB to PDCCH monitoring occasion association according to some yet other embodiments of the present application.

FIG. 8 illustrates a block diagram of an exemplary wireless communication apparatus according to some embodiments of the present application.

FIG. 9 illustrates a block diagram of an exemplary wireless communication apparatus according to some other embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP LTE, and so on. It is contemplated that along with the developments of network architectures and new service scenarios, all embodiments in the present application are also applicable to similar technical problems, and moreover, the terminologies recited in the present application may change, which should not affect the principle of the present application.

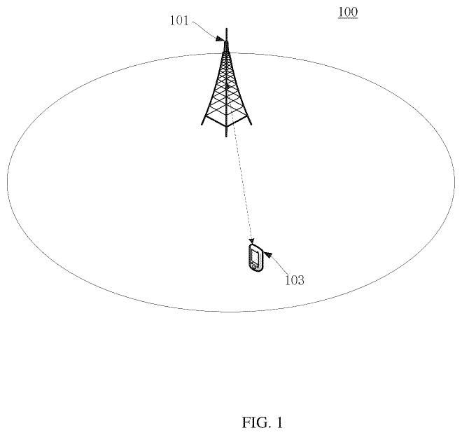

FIG. 1 illustrates a schematic diagram of an exemplary wireless communication system 100 according to some embodiments of the present application.

As shown in FIG. 1, the wireless communication system 100 includes a UE 103 and a BS 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

The BS 101 may transmit resource configuration information to the UE 103. A RS may be a channel state information (CSI) RS, an SSB, or an sounding reference signal (SRS) etc. In addition, a RS may be associated with a time domain filter, a frequency domain filter, or a spatial domain filter. Each beam (which may be represented by spatial relation information) of a BS or UE is associated with a spatial domain transmission or reception filter, which is associated with at least one RS. That is, each beam is also associated with at least one RS. From the perspective of the remote side, a downlink (DL) beam may be associated with a spatial domain reception filter, and an uplink (UL) beam may be associated with a spatial domain transmission filter. From the perspective of the network side, a DL beam may be associated with a spatial domain transmission filter, and a UL beam may be associated with a spatial domain reception filter. Thus, a beam being on or off can also be represented by a spatial domain filter being on or off.

In legacy technologies, e.g., NR R15 and R16, a beam being on or off is semi-statically indicated to the remote side (e.g., the UE side). For example, SSB indication is transmitted in SIB1 or RRC signaling. However, such a beam indication mechanism cannot well meet the energy saving requirement, which is an important item being studied and identified by 3GPP, specifically for greenfield deployments in the future.

Dynamically indicating beam on or off (also, referring to as “dynamic beam on/off indication mechanism” or “dynamic beam on/off indication”) can at least save energy in BS side and UE side. However, dynamic beam on/off indication mechanism will affect various communication procedures, e.g., RACH procedure and paging procedure. Thus, to well implement the dynamic beam on/off indication mechanism in wireless communication, all these impacts should be obviated.

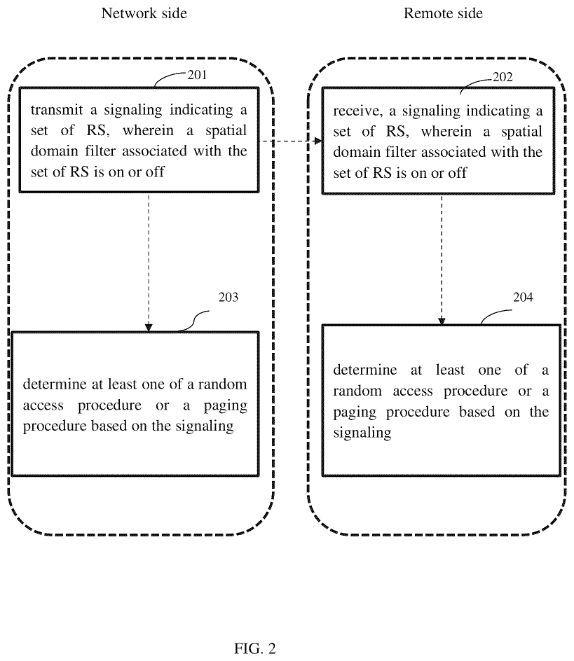

FIG. 2 is a flow chart illustrating an exemplary wireless communication method according to some embodiments of the present application. Although the method is illustrated in a system level by a remote apparatus in the remote side (e.g., the UE 103 as illustrated and shown in FIG. 1) and a RAN node in the network side (e.g., the BS 101 as illustrated and shown in FIG. 1), persons skilled in the art should understand that the method implemented in the remote side and that implemented in the network side can be separately implemented and/or incorporated by other apparatus with the like functions.

According to some embodiments of the present application, the network side, e.g., a gNB may dynamically indicate to the remote side one or more beams on or off, which can at least save network energy. For example, as shown in FIG. 2, in step 201, the network side, e.g., a gNB may transmit a signaling to the remote side, e.g., a UE, indicating a set of RS, where a spatial domain filter (i.e., beam) associated with the set of RS is indicated on or off. Herein, the wording “a/the set of” means “one or more” or “at least one” or the like. The signaling may also be referring to as “a beam on/off indication signaling” or “a beam status indication signaling” etc. Consistently, in step 202, the signaling will be received in the remote side (not considering data loss etc., factors). Persons skilled in the art should well know, the signaling for beam on/off indication may indicate the on/off status of more than one spatial domain filter, e.g., indicating a set of RS associated with a first domain filter being off, indicating another set of RS associated with a second domain filter being on, etc. In the case that the signaling indicates other spatial domain filter(s), the same or the like solution illustrated herein can be applied to other spatial domain filter(s) indicated by the signaling.

The set of RS may be SSB, CSI-RS, or SRS, etc. The signaling may indicate the set of RS by indicting the index of each RS. For example, an exemplary signaling may indicate SSB #1, SSB #3, and SRS resource #2 associated with a spatial domain filter indicated off.

The signaling can be various dynamic signaling. For example, in some embodiments of the present application, the signaling is MAC CE, scheduling DCI, or group common DCI. In some other embodiments of the present application, the signaling may be a UE specific DCI.

The signaling is associated with a time domain duration beginning from a time instance, which indicates when the UE will start to perform data transmission ( ) based on the signaling and how long the signaling is supposed to be applicable for the UE. As stated above, the data transmission should be understood in a broad sense, such as including control transmission, or RS transmission, etc., referred to hereafter the same. The time instance can be determined based on a predefined rule or is configured by a higher layer (e.g., layer higher than physical layer) signaling, e.g., RRC signaling or MAC CE. The time instance is determined based on a configured or predefined time domain delay between reception of the signaling and application of the signaling in the remote apparatus. In some other embodiments of the present application, in the case of the signaling being group common DCI, the time instance may be determined as a slot boundary associated with the group common DCI based on a predefined rule, e.g., the starting boundary or the ending boundary of the group common DCI transmission slot or the group common DCI reception slot in the UE side. Regarding the time domain duration, it is configured by RRC or MAC CE, etc., higher layer signaling. The time domain duration is presented in a unit of millisecond, or in a unit of slot or other units. In the case that the unit is slot, a length of the slot is determined by configured subcarrier spacing (SCS), or by SCS determined implicitly. For example, the SCS can be based on frequency band. In an alternative example, the SCS can be the same as the group common DCI carrying the signaling. In another alternative example, the SCS can be the same as the SCS associated with other group common DCI, e.g., DCI 2-0 or DCI 2-5.

According to some embodiments of the present application, the time domain duration is further divided into a plurality of sub-durations, and different sub-durations are associated with different RSs whose associated spatial domain filter are set on or set off. In other words, different sub-durations are associated with different spatial domain filters being set on. For example, the signaling indicates beam on/off for 100 ms by indicating a pattern, and the 100 ms are divided into 10 sub-durations, each with 10 ms. Specifically, 0-9 ms is associated with beam status (i.e., on or off) indication #0, 10-19 ms is associated with beam status indication #1, . . . 90-99 ms is associated with beam status indication #9. Moreover, according to the signaling: for beam status #0, the beams associated with SSB #1, SSB #3 and SRS resource #2 is on: for beams status #1, the beams associated with CSI-RS resource #2 and CSI-RS resource index #5 is on: . . . and for beam status #9, the beam associated with SSB #2, CSI-RS resource index #2, CSI-RS resource index #6, and SRS resource #3 is on.

In addition, the signaling can indicate whether the spatial domain filter associated with the set of RS is on or off in various manners. For example, the signaling may indicate whether the spatial domain filter associated with the set of RS is on or off by a bitmap corresponding to each RS of the set of RS. For example, “1” means on, and “0” means off in the bitmap. For a signaling in pattern, multiple bitmaps will be used to indicate the pattern.

In some other embodiments of the present application, the signaling may indicate whether the spatial domain filter associated with the set of RS is on or off by codepoints. Each codepoint indicates a group containing at least one RS associated with a spatial domain filter being on (i.e., a group only including RS associated with a spatial domain filter being on) or a group containing at least one RS associated with a spatial domain filter being off (i.e., a group only including RS associated with a spatial domain filter being off). For a RS, whether within the group containing at least one RS associated with a spatial domain filter being on, or within the group containing at least one RS associated with a spatial domain filter being off is predefined or configured by a higher layer signaling, e.g., RRC or MAC CE. In other words, the at least one RS within a group can be predefined or configured by higher layer signaling. For example, a group contains at least one of: SSB, CSI-RS, and SRS. SSB and/or CSI-RS and/or SRS may be indicated within one group by RRC with a group index, wherein SSB index and/or CSI-RS resource index and/or SRS resource index associated with a spatial domain filter which is considered to be on, are indicated by a group index, and others associated with another spatial domain filter which is considered to be off, are not indicated by the group index or indicated by another group index. Group common DCI can be used to indicate one of the groups. Alternatively, a group can be configured with at least one of: SSB resource, CSI-RS resource, SRS resource by the resource index, and when the group index is indicated by a beam status indication signaling, the spatial domain filter associated with all RS within the group will be considered to be on. For a signaling in pattern, sequence of group indexes will be used to indicate the pattern.

In the network side, at least one of a RACH procedure or paging procedure will be determined based on the signaling in step 203: and similarly, in the remote side, at least one of a RACH procedure or paging procedure will be determined based on the signaling in step 204. Thus, for the RACH procedure and paging procedure, the network side and the remote side will adopt proper measures based on the signaling according to some embodiments of the present application, and accordingly will obviate the great impact on the RACH procedure and paging procedure associated with the beam being dynamically indicated on or off.

More details on how to determine the RACH procedure and paging procedure will be illustrated below in view of various exemplary embodiments of the present application. Herein, for simplification and clearness, “a spatial domain filter (or beam) indicated (or being) on or off” always means that such an indication (or signaling) has been applied in the UE side and/or network side. Although most exemplary embodiments of determining a RACH procedure or paging procedure are illustrated in view of RS(s) being SSB, persons skilled in art should well know that that the RS(s) may be CSI-RS or other RS(s) for the RACH procedure or paging procedure.

### IMPACT ON RACH PROCEDURE

In some scenarios, the application of dynamic beam on/off indication mechanism may affect the RACH procedure. A RACH procedure is also referred to as a PRACH procedure, which includes 4-step RACH procedure and 2-step RACH procedure. For example, in a 2-step RACH procedure, there are only two steps, i.e., transmitting MsgA which contains both preamble in RO(s) and PUSCH in PUSCH occasion(s) from a UE to the network side, e.g., a BS, and receiving MsgB in response to MsgA from the network side.

According to some embodiments of the present application, if a beam (e.g., spatial domain filter) is indicated off, then the beam will not be used for the RACH procedure. Not using the beam for the RACH procedure can start in various manners after the application of the indication signaling. For example, not using the beam for the RACH procedure can start from the starting boundary of the smallest SSB to RO mapping cycle (or other RS to RO mapping cycle in view of other RS, hereafter the same), or the starting boundary of the smallest SSB to RO association pattern period (or other RS to RO association pattern period in view of other RS, hereafter the same), or the starting boundary of the smallest SSB to RO association period (or other RS to RO association period in view of other RS, hereafter the same), which is after the application of the indication signaling. The mapping cycle is a number of ROs, which is determined by the number of ROs per SSB and the number of SSBs. For example, if there are 10 SSBs configured by signaling, and each SSB is associated with 2 ROs, then each RO occupies a PRACH slot in time domain and 6 PRBs in frequency domain, and there are in total 12 physical radio blocks (PRB) s used for PRACH procedure, so that there are 2 ROs in frequency domain with the same time domain resource. The mapping cycle will include 10 PRACH slots in time domain. For example, slots in time domain are sequentially numbered as, slot #0, slot #1, solt #3 . . . slot #21, slot #22. Supposing that the first PRACH slot is slot #3, then the first mapping cycle, e.g., mapping cycle #1, will start from slot #3. If the 11^{th} PRACH slot starts from slot #22, then mapping cycle #1 ends at slot #21. Both the association pattern period and the association period are multiples of mapping cycles. For example, an association period is 4 mapping cycles, and an association pattern period is 8 mapping cycles considering time division duplex (TDD) configuration in the cell. For example, a plurality of SSBs, e.g., SSB #0, #1, #2 . . . #9 are indicated firstly, and then SSB #3 is indicated to be off at slot #0, and it is applied at slot #1. Then, the beam associated with SSB #3 not used for PRACH transmission will start from the starting boundary of mapping cycle #1, i.e., slot #3.

Regarding RO, it is an area specified in time and frequency domain that are available for the transmission of preamble, and time domain RO is the smallest time domain resource unit for a preamble transmission. In LTE, all the possible preambles share the same RO specified by RRC message (e.g., SIB2), but the story gets more complicated in NR. In NR, different SSBs are associated with different beams and a UE can select a certain beam (downlink spatial domain filter) and send a preamble on a RO associated with that beam (transmission and reception use the same spatial domain filter). NR R15 has defined a specific mapping relationship between SSBs (or SSB indices for identifying the SSBs) and ROs, so that the network side can figure out which SSB or beam that the UE has selected by detecting which RO the UE sent the preamble on. In other words, a RO is associated with an SSB or SSB index to implicitly indicate the selected beam for downlink transmission and if applied, as well as uplink transmission.

Thus, whether and how the SSB to RO association is affected by the dynamic beam on/off indication mechanism should be considered. Similarly, the impact on the association of SSB with PUSCH occasion caused by the dynamic beam on/off indication mechanism should also be considered.

In some embodiments of the present application, regardless of the beam being dynamically indicated on or off, the SSB to RO association or the association of SSB with PUSCH occasion maintains the same.

For example, if a beam, e.g., a spatial domain filter is off, neither a PUSCH occasion associated with the spatial domain filter nor a RO associated with the spatial domain filter will be used for the random access procedure, which can start in the same manner as not using the beam being indicated off. On the other hand, if a beam, e.g., a spatial domain filter, is indicated on, at least one of the PUSCH occasion associated with the spatial domain filter or RO associated with the spatial domain filter will be used for the random access procedure. Meanwhile, if a beam (e.g., a spatial domain filter) is indicated on, at least one of the PUSCH occasion or RO associated with the spatial domain filter will be valid for the RACH procedure. Herein (throughout the specification), the wording “at least one of A or B” and “at least one of A and B” both mean: A, or B, or both A and B.

In some other embodiments of the present application, the SSB to RO association will change in the case of a beam associated with the SSB being dynamically indicated on or off. For example, the SSB to RO association will be updated for all or partial ROs based on a set of SSB whose associated spatial domain filter is on, which may be at a start of at least one of an association period, a mapping cycle, or an association pattern period. The SSB to RO association period is an association period nearest to the application of the signaling among a plurality of association periods later than the application of the signaling. The SSB to RO mapping cycle is a mapping cycle nearest to the application of the signaling among a plurality of mapping cycles later than the application of the signaling. The SSB to RO association pattern period is an association pattern period nearest to the application of the signaling among a plurality of association pattern periods later than the application of the signaling.

According to some other embodiments of the present application, the SSB to RO association is updated for partial ROs by updating the SSB to RO association for at least one association period, or for at least one mapping cycle, or for at least one association pattern period. The at least one mapping cycle can be configured, e.g., by RRC signaling etc., with high layer signaling in some embodiments of the present application. In some other embodiments of the present application, the at least one mapping cycle can be determined based on SSB, or based on PRACH periodicity and offset configuration, or based on PUSCH periodicity and offset configuration. For example, it can be configured or predefined by a value, e.g., n/N (both n and N are an integer larger than 0), so that only the first (or the last, which depends on the specific rules) n mapping cycle(s) of every N mapping cycles will update the SSB to RO association, and other mapping cycle(s) will maintain the same, e.g., as configured in a legacy manner. In some other embodiments of the present application, n/N may refer to n association period(s) of every N association periods, or n association pattern period(s) of every N association pattern periods.

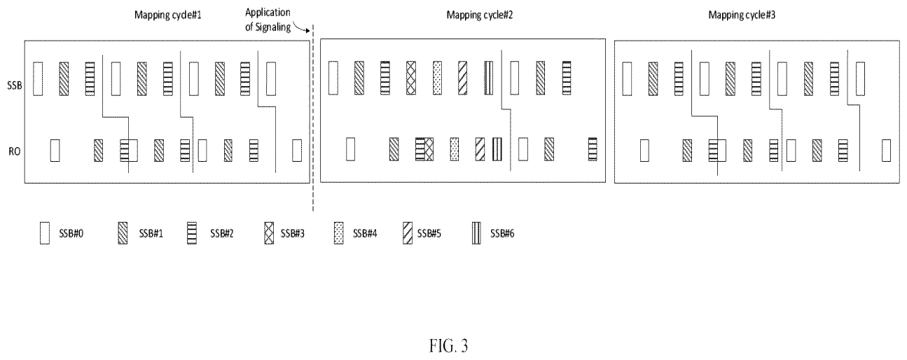

FIG. 3 is a schematic diagram illustrating an exemplary procedure of updating SSB to RO association according to some embodiments of the present application.

Referring to FIG. 3, three mapping cycles, e.g., mapping cycle #1, mapping cycle #2 and mapping cycle #3 are shown. In mapping cycle #1, the SSB to RO association is configured, e.g., by a RRC signaling. For example, 3 SSBs, i.e., SSB #0, SSB #1 and SSB #2 are provided for the RACH procedure, the spatial domain filter associated with these SSBs are on, each SSB is associated with a RO, the PRACH periodicity is 40 ms and the offset is 20 ms, so that the PRACH procedure will occur in duration 20-39 ms, 60-79 ms, etc. This can be configured for UE with legacy capability. It is supposed that a dynamic beam on/off indication signaling is applicable after mapping cycle #1, which indicates more SSBs for the RACH procedure, e.g., SSB #3, SSB #4, SSB #5 and SSB #6, wherein the spatial domain filter associated with these SSB is also on. The indication can be SSB indices #0, #1, #2, #3, #4, #5, #6, which configures all the SSB indices being on. In some other embodiments of the present application, the indication can be SSB indices #3, #4, #5, #6, which configures at least one additional SSB index being on in addition to that configured in SIB or RRB signaling. This is applicable for UEs with the novel capability as proposed in the present application. As a result, the legacy SSB to RO association (with SSB indices #0, #1, #2) will be applied to time duration 20-39 ms, 60-79 ms, etc. The new SSB to RO association (with SSB indices #0, #1, #2, #3, #4, #5, #6) will be applied to time duration 40-59 ms, 80-99 ms, etc.

According to some embodiments of the present application, the SSB to RO association will be updated for partial ROs at a start of the mapping cycle nearest to the application of the signaling among a plurality of mapping cycles after the application of the signaling, e.g., mapping cycle #2. It is supposed that a value ½ is provided and it is configured or predefined that the last one of every two mapping cycles will maintain the same. Accordingly, in the last ½ of mapping cycle #2 and mapping cycle #3, i.e., mapping cycle #3, the SSB to RO association will maintain the same as the originally configured: while in the first ½ of mapping cycle #2 and mapping cycle #3, i.e., mapping cycle #2, the SSB to RO association will be updated based on the beam on/off indication signaling. That is, each one of SSB #0-6 will be associated with a corresponding RO sequentially within mapping cycle #2.

According to some other embodiments of the present application, the SSB to RO association is updated for partial ROs by updating the SSB to RO association for at least one SSB of the set of SSB. The at least one SSB is configured e.g., by RRC signaling etc., high layer signaling, or is determined based on SSB index configuration in at least one of SIB1, RRC, MAC CE or group DCI. For example, it may be configured that the SSB to RO association for SSB #0, SSB #1 and SSB #2 are kept the same for all mapping cycles, and the SSB to RO association for other SSBs will be updated based on the beam on/off indication signaling in each mapping cycle. In this manner, there may be different SSB index configurations for legacy SSB to RO association and the updated SSB to RO association.

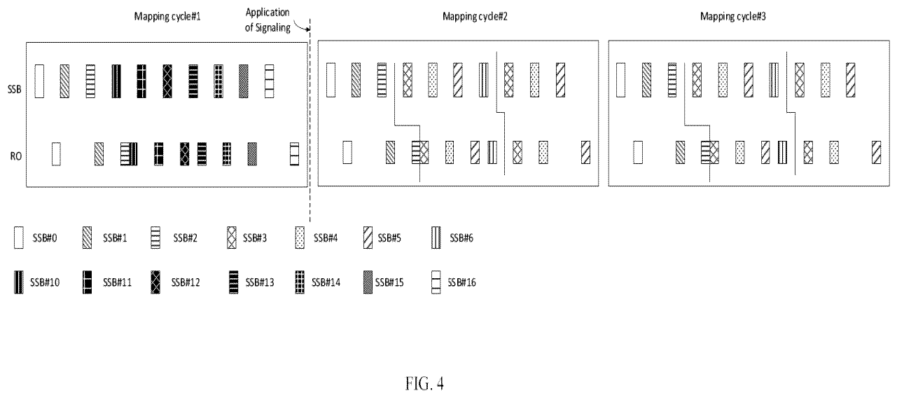

FIG. 4 is a schematic diagram illustrating an exemplary procedure of updating SSB to RO association according to some other embodiments of the present application.

Referring to FIG. 4, three mapping cycles, e.g., mapping cycle #1, mapping cycle #2 and mapping cycle #3 are shown. In mapping cycle #1, the SSB to RO association is configured, e.g., by a RRC signaling. For example, 10 SSBs, i.e., SSB #0-2 and SSB #10-16 are provided for the RACH procedure, the spatial domain filters associated with these SSBs are on, each SSB is associated with a RO, the PRACH periodicity is 20 ms and the offset is 0 ms, so that the PRACH procedure will occur in duration 0-19 ms, 20-39 ms, 40-59 ms, 60-79 ms, etc. This is applicable for UEs with legacy capability. Although the configuration is SSB #0-2 and SSB #10-16, only SSB #0-2 will be transmitted by the network. SSB #10-16 will not be transmitted. Accordingly, the UE will only select RO associated with SSB #0-2 for RACH transmission. It is supposed that a dynamic beam on/off indication signaling is applicable after mapping cycle #1, which dynamically indicates different SSBs for the RACH procedure, e.g., SSB #10-16 are invalid due to the associated spatial domain filter being off, SSB #3, SSB #4, SSB #5 and SSB #6 are valid due to the associated spatial domain filter being on. The signaling can be SSB #0-6, which indicates the SSB being on. In this case, for UE with legacy capability, the SSB to RO association for SSB #0-2 will keep the same for all mapping cycles, so that RO in each mapping cycle can be used for random access. For UE with novel capability as proposed in the present application, the SSB to RO association for SSB #0-6 will be adopted for all mapping cycles after the application of the dynamic beam on/off indication signaling. As for all mapping cycles, SSB to RO association for SSB #0-2 is the same, so that UE with legacy capability and UE with novel capability as proposed in the present application can coexist in the same network. In addition, it can also be configured or predefined that the SSB to RO association for the first three SSBs will maintain the same in each mapping cycle, and the SSB to RO association for other SSBs will be updated based on the beam on/off indication signaling.

Then, the SSB to RO association will be updated for partial ROs based on the SSB whose associated spatial domain filter is on by updating the SSB to RO association for SSB #3-6 and SSB #10-16. That is, if the SSB being on is changed from SSB #10-16 to SSB #3-6 and the status of SSB #0-2 is the same, then the RO previously used for association with SSB #10-16 will change to be associated with SSB #3-6. According to some embodiments of the present application, the SSB to RO association will be updated for partial ROs at a start of the mapping cycle nearest to the application of the signaling among a plurality of mapping cycles after the application of the signaling, e.g., mapping cycle #2. Accordingly, for ROs associated with the first three SSBs, e.g., SSB #0, SSB #1 and SSB #2 in mapping cycle #2 and mapping cycle #3, the SSB to RO association will maintain the same as the original configured: while for other ROs associated with other SSBs, i.e., ROs associated with SSB #10-16, the SSB to RO association will be updated based on the signaling in mapping cycle #2 and mapping cycle #3, that is, each of ROs associated with SSB #10-16 in mapping cycle #1 will be associated with a corresponding SSB of SSB #3-6 sequentially within mapping cycle #2 and mapping cycle #3.

In addition, according to some embodiments of the present application, whether a RO or PUSCH occasion is valid for the RACH procedure is dependent on whether the beam is on or off.

For example, in some embodiments of the present application, in the case of the spatial domain filter being on, a RO which does not precede an SSB in a PRACH slot and starts after a gap from the last SSB reception symbol based on an SSB associated with the spatial domain filter being on, is valid. An exemplary procedure of determining whether a RO is valid based on an SSB associated with spatial domain filter is provided in the following, which improves that specified in TS38.213:
For unpaired spectrum,
   if a UE is not provided tdd-UL-DL-ConfigurationCommon, a PRACH occasion in a PRACH slot is valid if it does not precede a SS/PBCH block in the PRACH slot and starts at least N_{gap} symbols after a last SS/PBCH block reception symbol, where N_{gap} is provided in Table 8.1-2 and, if channelAccessMode=semistatic is provided, does not overlap with a set of consecutive symbols before the start of a next channel occupancy time where the UE does not transmit [15, TS 37.213].
      the candidate SS/PBCH block index of the SS/PBCH block corresponds to the SS/PBCH block index provided by ssb-PositionsInBurst in SIB1 or in ServingCellConfigCommon or in the dynamic beam on/off signaling by group common DCI or MAC CE, as described in Clause 4.1
   If a UE is provided tdd-UL-DL-ConfigurationCommon, a PRACH occasion in a PRACH slot is valid if
      it is within UL symbols, or
      it does not precede a SS/PBCH block in the PRACH slot and starts at least N_{gap} symbols after a last downlink symbol and at least N_{gap} symbols after a last SS/PBCH block symbol, where N_{gap} is provided in Table 8.1-2, and if channelAccessMode=semistatic is provided, does not overlap with a set of consecutive symbols before the start of a next channel occupancy time where there shall not be any transmissions, as described in [15, TS 37.213]
         the candidate SS/PBCH block index of the SS/PBCH block corresponds to the SS/PBCH block index provided by ssb-PositionsInBurst in SIB1 or in ServingCellConfigCommon or in the dynamic beam on/off signaling by group common DCI or MAC CE, as described in Clause 4.1.

Similarly, in the case of the spatial domain filter being on, a PUSCH occasion, which does not precede an SSB in a PUSCH slot and starts after a gap from the last SSB reception symbol based on an SSB associated with the spatial domain filter being on, is valid. An exemplary procedure of determining whether a PUSCH occasion is valid based on an SSB associated with spatial domain filter is provided in the following, which improves that in current 38.213:
A PUSCH occasion is valid if it does not overlap in time and frequency with any valid PRACH occasion associated with either a Type-1 random access procedure or a Type-2 random access procedure. Additionally, for unpaired spectrum and for SS/PBCH blocks with indexes provided by ssb-PositionsInBurst in SIB1 or by ServingCellConfigCommon or in the dynamic beam on/off signaling by group common DCI or MAC CE
   if a UE is not provided tdd-UL-DL-ConfigurationCommon, a PUSCH occasion is valid if the PUSCH occasion
      does not precede a SS/PBCH block in the PUSCH slot, and
      starts at least N_{gap} symbols after a last SS/PBCH block symbol, where N_{gap} is provided in Table 8.1-2
   if a UE is provided tdd-UL-DL-ConfigurationCommon, a PUSCH occasion is valid if the PUSCH occasion
      is within UL symbols, or
      does not precede a SS/PBCH block in the PUSCH slot, and
      starts at least N_{gap} symbols after a last downlink symbol and at least N_{gap} symbols after a last SS/PBCH block symbol, where N_{gap} is provided in Table 8.1-2 and, if channelAccessMode=semistatic is provided, does not overlap with a set of consecutive symbols before the start of a next channel occupancy time where the UE does not transmit [15, TS 37.213].

In some scenarios, a RO associated with a spatial domain filter may overlap a downlink channel or a downlink RS in time domain. In the case of the spatial domain filter being off, the network side will transmit the downlink channel or the downlink RS due to the RO being invalid or not to be used; and in the case that the spatial domain filter is on, the network side will not transmit the downlink channel or the downlink RS due to the RO being valid or to be used. Similarly, in the case of the spatial domain filter being off, the UE will receive the downlink channel or the downlink RS due to the RO being invalid or not to be used; and in the case of the spatial domain filter being on, the network side will not receive the downlink channel or the downlink RS due to the RO being valid or to be used.

An exemplary procedure of determining whether a reception will be expected in the UE considering the overlap of RO(s) with a downlink channel or a downlink RS in time domain is provided in the following, which improves that in current TS 38.213:
For a set of symbols of a slot corresponding to a valid PRACH occasion and N_{gap} symbols before the valid PRACH occasion, as described in Clause 8.1 of TS38. 213, the UE does not receive PDCCH, PDSCH, or CSI-RS in the slot if a reception would overlap with any symbol from the set of symbols. The UE does not expect the set of symbols of the slot to be indicated as downlink by tdd-UL-DL-ConfigurationCommon or tdd-UL-DL-ConfigurationDedicated. Whether a PRACH occasion is determined based on the RS being on indicated by the dynamic signaling in group common DCI or MAC CE.

Persons skilled in the art should well know that the solution(s) illustrated in view of SSB to RO association or SSB to PUSCH occasion association may also be applied to other RS, e.g., CSI-RS used for the RACH procedure.

### IMPACT ON PAGING PROCEDURE

In some scenarios, the application of dynamic beam on/off indication mechanism may affect the paging procedure. For the paging procedure, there is a mapping between SSB and PDCCH monitoring occasion. The number of SSB is determined by SIB1 in NR R16 as follows:
When SearchSpaceld other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0,1, . . . , X−1, K=1,2, . . . , S. The PDCCH monitoring occasions for paging which do not overlap with UL symbols according (determined to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th} value of the firstPDCCH-MonitoringOccasionOfPO parameter: otherwise, it is equal to i_s*S*X. If X>1, when the UE detects a PDCCH transmission addressed to P-RNTI within its PO, the UE is not required to monitor the subsequent PDCCH monitoring occasions for this PO.

In some embodiments of the present application, in the case of the spatial domain filter being off, it is expected to not transmit PEI associated with the spatial domain filter being off in the network side, e.g., by a RAN node, and not monitor PEI associated with the spatial domain filter being off in the remote side, e.g., by the UE. That is, the association of SSB with PDCCH monitoring occasion for paging will not change or update even if the beam is dynamically indicated on or off.

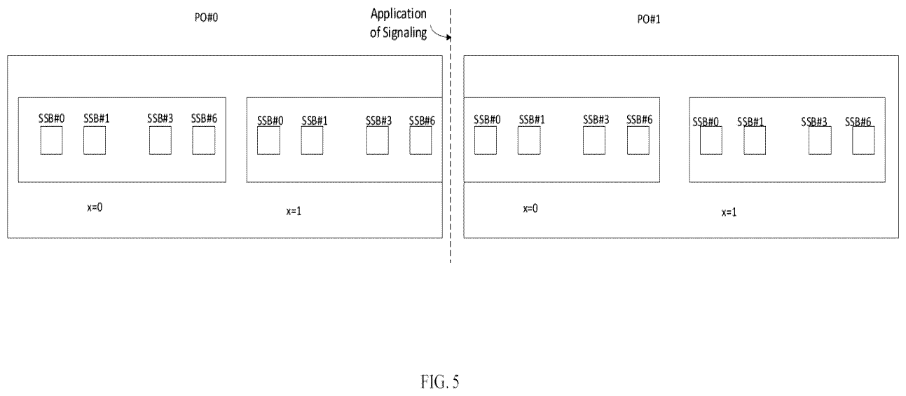

FIG. 5 is a schematic diagram illustrating an exemplary procedure of updating SSB to PDCCH monitoring occasion association according to some embodiments of the present application.

Referring to FIG. 5, two POs, e.g., PO #0 and PO #1 are illustrated. A number of PDCCH monitoring occasions per SSB in each PO, i.e., “X” is 2. The number of actual transmitted SSBs for PO #0, i.e., “S” is 4, which include SSB #0, SSB #1, SSB #3 and SSB #6. Thus, within PO #0, for each of x=0 and x=1, there are four PDCCH monitoring occasions (represented by each smallest block in FIG. 5) respectively associated with SSB #0, SSB #1, SSB #3 and SSB #6.

A beam on/off indication signaling is applicable after PO #0 and before PO #1, which indicates that the spatial domain filter associated with SSB #1 and SSB #6 is off. The spatial domain filter associated with SSB #0 and SSB #3 is still on. However, the association of SSB with PDCCH monitoring occasion for paging in PO #1 will not change or update, that is, the association of SSB with PDCCH monitoring occasion in PO #1 is the same as that in PO #0. The RAN node will not transmit PEI on the PDCCH monitoring occasions associated with SSB #1 and SSB #6, and the UE will not monitor the PEI on the PDCCH monitoring occasions associated with SSB #1 and SSB #6.

In some embodiments of the present application, the association of SSB PDCCH monitoring occasion for paging will change or update in response to the beam being dynamically indicated on or off. For example, in the case of the spatial domain filter being on, a PO is a set of “S*X” consecutive PDCCH monitoring occasions, where “X” is a number of PDCCH monitoring occasions per SSB in PO, and “S” is a number of SSBs associated with the spatial domain filter being on rather than the legacy meaning in R16. Dependent on whether the first PDCCH monitoring occasion of PO for the updating is configured, the starting PDCCH monitoring occasion for different POs may be discontinuous or continuous.

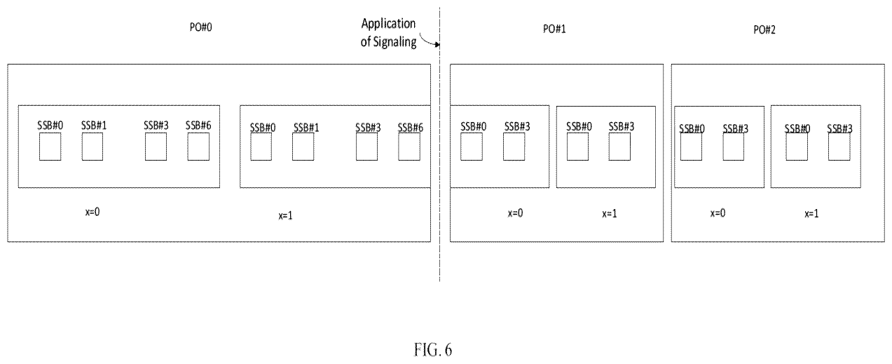

FIG. 6 is a schematic diagram illustrating an exemplary procedure of updating SSB to PDCCH monitoring occasion association according to some other embodiments of the present application, wherein the first PDCCH monitoring occasion of PO for the updating is not configured.

Referring to FIG. 6, three POs, e.g., PO #0, PO #1, and PO #2 are illustrated. A number of PDCCH monitoring occasions per SSB in each PO, i.e., “X”, is 2. The number of SSBs associated with the spatial domain filter being on for PO #0, i.e., “S”, is 4, which include SSB #0, SSB #1, SSB #3, and SSB #6. Thus, within PO #0, for each of x=0 and x=1, there are four PDCCH monitoring occasions (represented by each smallest block in FIG. 6) respectively associated with SSB #0, SSB #1, SSB #3 and SSB #6.

A beam on/off indication signaling is applicable after PO #0 and before PO #1, which indicates that the spatial domain filter associated with SSB #1 and SSB #6 is off. The spatial domain filter associated with SSB #0 and SSB #3 is still on. Then, “S” will be two. Considering that the first PDCCH monitoring occasion of PO is not configured, the starting PDCCH monitoring occasion for different POs are continuous. PO #1 and PO #2 only contain the PDCCH monitoring occasion associated with SSB #0 and SSB #3, and there is no PDCCH monitoring occasion associated with SSB #1 and SSB #6.

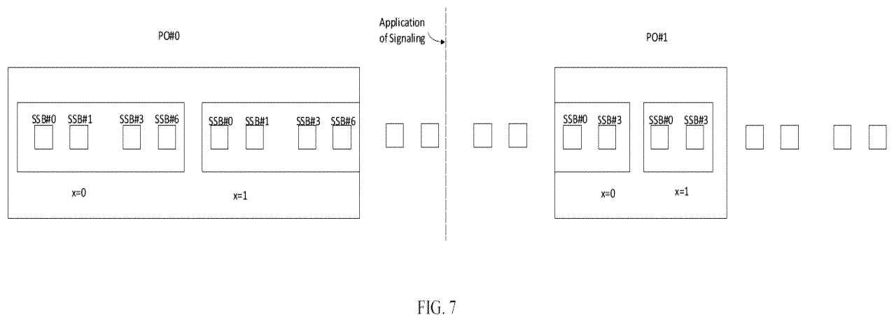

FIG. 7 is a schematic diagram illustrating an exemplary procedure of updating SSB to PDCCH monitoring occasion association according to some yet other embodiments of the present application, wherein the first PDCCH monitoring occasion of PO for the updating is configured.

Referring to FIG. 7, two POs, e.g., PO #0 and PO #1 are illustrated. A number of PDCCH monitoring occasions per SSB in each PO, i.e., “X”, is 2. The number of SSBs associated with the spatial domain filter being on for PO #0, i.e., “S”, is 4, which include SSB #0, SSB #1, SSB #3, and SSB #6. Thus, within PO #0, for each of x=0 and x=1, there are four PDCCH monitoring occasions (represented by each smallest block in FIG. 7) respectively associated with SSB #0, SSB #1, SSB #3, and SSB #6.

A beam on/off indication signaling is applicable after PO #0 and before PO #1, which indicates that the spatial domain filter associated with SSB #1 and SSB #6 is off. The spatial domain filter associated with SSB #0 and SSB #3 is still on. Then, “S” will be two. Considering that the first PDCCH monitoring occasion of PO, e.g., the fifth PDCCH monitoring occasion after the application of the signaling is configured, the starting PDCCH monitoring occasions for different POs are discontinuous. PO #1 only contain the PDCCH monitoring occasion associated with SSB #0 and SSB #3, and there is no PDCCH monitoring occasion associate with SSB #1 and SSB #6.

Regarding when to update the association of SSB with PDCCH monitoring occasions for paging, there are various manners. In an example, the association of SSB with PDCCH monitoring occasion for paging is updated at the starting boundary of the nearest PO among a plurality of POs after the application of the signaling. In another example, the association of SSB with PDCCH monitoring occasion for paging is updated at a time instance determined by a number of POs indicated in a PEI. If a PEI indicates whether to monitor paging for two continuous POs, e.g., PO #1 and PO #2, then the time instance of the updating can only be the starting boundary of PO #1 or PO #3, and cannot be the starting boundary of PO #2. In yet another example, the association of SSB with PDCCH monitoring occasion for paging is updated at the starting boundary of the nearest paging frame among a plurality of paging frames after the application of the signaling. In yet another example, the association of SSB with PDCCH monitoring occasion for paging is updated at the starting boundary of the nearest DRX cycle among a plurality of DRX cycles after the application of the signaling.

Similarly, persons skilled in the art should well know that the solution(s) illustrated in view of SSB to PDCCH monitoring occasion association may also be applied to other RS(s), e.g., CSI-RS used for the paging procedure.

Besides the methods, embodiments of the present application also propose a wireless communication apparatus.

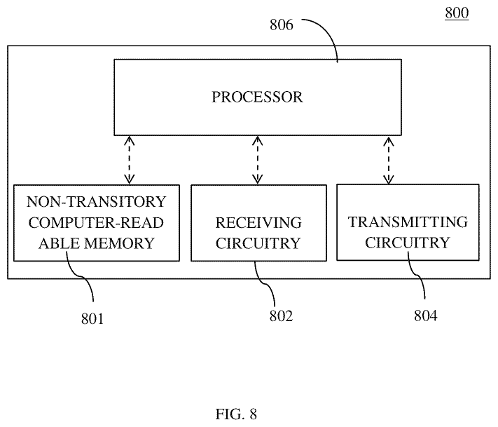

For example, FIG. 8 illustrates a block diagram of a wireless communication apparatus 800 according to some embodiments of the present application.

As shown in FIG. 8, the apparatus 800 may include at least one non-transitory computer-readable medium 801, at least one receiving circuitry 802, at least one transmitting circuitry 804, and at least one processor 806 coupled to the non-transitory computer-readable medium 801, the receiving circuitry 802 and the transmitting circuitry 804. The at least one processor 806 may be a CPU, a DSP, a microprocessor etc. The apparatus 800 may be a RAN node, e.g., a gNB, or a remote apparatus, e.g., UE, configured to perform a method illustrated in the above or the like.

Although in this figure, elements such as the at least one processor 806, transmitting circuitry 804, and receiving circuitry 802 are described in the singular, the plural is contemplated unless a limitation to the singular is explicitly stated. In some embodiments of the present application, the receiving circuitry 802 and the transmitting circuitry 804 can be combined into a single device, such as a transceiver. In certain embodiments of the present application, the apparatus 800 may further include an input device, a memory, and/or other components.

In some embodiments of the present application, the non-transitory computer-readable medium 801 may have stored thereon computer-executable instructions to cause a processor to implement the method with respect to the network apparatus as described above. For example, the computer-executable instructions, when executed, cause the processor 806 interacting with receiving circuitry 802 and transmitting circuitry 804, so as to perform the steps with respect to the network apparatus as depicted above.

In some embodiments of the present application, the non-transitory computer-readable medium 801 may have stored thereon computer-executable instructions to cause a processor to implement the method with respect to the UE as described above. For example, the computer-executable instructions, when executed, cause the processor 806 interacting with receiving circuitry 802 and transmitting circuitry 804, so as to perform the steps with respect to the UE as illustrated above.

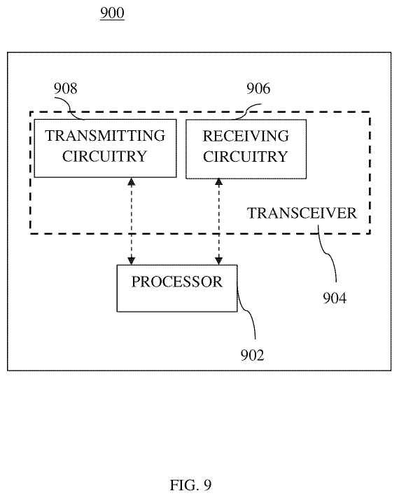

FIG. 9 is a block diagram of a wireless communication apparatus according to some other embodiments of the present application.

Referring to FIG. 9, the apparatus 900, for example a gNB or a UE, may include at least one processor 902 and at least one transceiver 904 coupled to the at least one processor 902. The transceiver 904 may include at least one separate receiving circuitry 906 and transmitting circuitry 904, or at least one integrated receiving circuitry 906 and transmitting circuitry 904. The at least one processor 902 may be a CPU, a DSP, a microprocessor etc.

According to some embodiments of the present application, when the apparatus 900 is a remote apparatus, the processor is configured to: receive a signaling indicating at least one RS, wherein a spatial domain filter associated with the at least one RS is on or off; and determine at least one of a random access procedure or a paging procedure based on the signaling.

According to some other embodiments of the present application, when the apparatus 900 is a RAN node, e.g., a gNB, the processor may be configured to: transmit a signaling indicating at least one RS, wherein a spatial domain filter associated with the at least one RS is on or off; and determine at least one of a random access procedure or a paging procedure based on the signaling.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE) comprising:
a memory;
at least one receiving circuitry;
at least one transmitting circuitry; and
at least one processor coupled to the memory, the at least one receiving circuitry and the at least one transmitting circuitry, wherein the at least one processor is configured to cause the UE to:
receive, via the at least one receiving circuitry, a signaling indicating at least one reference signal (RS), wherein a spatial domain filter associated with the at least one RS is on or off; and
determine at least one of a random access procedure or a paging procedure based on the signaling.

2. The UE according to claim 1, wherein, to determine a random access procedure based on the signaling, the at least one processor is configured to cause the UE to:
not use at least one of the spatial domain filter, a physical uplink shared channel (PUSCH) occasion associated with the spatial domain filter, or a physical random access channel (PRACH) occasion (RO) associated with the spatial domain filter for the random access procedure in the case of the spatial domain filter being off.

3. The UE according to claim 1, wherein, in determining a random access procedure based on the signaling, at least one of physical uplink shared channel (PUSCH) occasion or physical random access channel (PRACH) occasion (RO) associated with the spatial domain filter is valid for the random access procedure, in the case of the spatial domain filter being on.

4. The UE according to claim 1, wherein, in the case that a physical random access channel (PRACH) occasion (RO) associated with the spatial domain filter overlaps a downlink channel or a downlink RS in time domain, the at least one processor is configured to cause the UE to:
receive the downlink channel or the downlink RS in the case of the spatial domain filter being off; or
not receive the downlink channel or the downlink RS in the case of the spatial domain filter being on.

5. The UE according to claim 1, wherein, to determine a random access procedure based on the signaling, the at least one processor is configured to cause the UE to:
update synchronization signal (SS)/physical broadcast channel (PBCH) block (SSB) to physical random access channel (PRACH) occasion (RO) association is updated for all or partial ROs based on a set of SSB whose associated spatial domain filter is on.

6. The UE according to claim 5, wherein the at least one processor is configured to update the SSB to RO association for all or partial ROs at a start of at least one of an association period, a mapping cycle, or an association pattern period.

7. The UE according to claim 6, wherein,
the association period is an association period nearest to application of the signaling among a plurality of association period later than the application of the signaling;
the mapping cycle is a mapping cycle nearest to application of the signaling among a plurality of mapping cycles later than the application of the signaling; or
the association pattern period is an association pattern period nearest to application of the signaling among a plurality of association pattern periods later than the application of the signaling.

8. The UE according to claim 5, wherein, to update the SSB to RO association for partial Ros, the at least one processor is configured to update the SSB to RO association for at least one SSB of the set of SSB.

9. The UE according to claim 1, wherein, in determining a random access procedure based on the signaling, in the case of the spatial domain filter being on, a physical random access channel (PRACH) occasion (RO) which does not precede a synchronization signal (SS)/physical broadcast channel (PBCH) block (SSB) in a PRACH slot and starts after a gap from a last SSB reception symbol based on an SSB associated with the spatial domain filter, is valid.

10. The UE according to claim 1, wherein, in determining a paging procedure based on the signaling, in the case of the spatial domain filter being on, a paging occasion (PO) is a set of “S*X” consecutive physical downlink control channel (PDCCH) monitoring occasions, where “X” is a number of PDCCH monitoring occasions per synchronization signal (SS)/physical broadcast channel (PBCH) block (SSB) in PO, and “S” is a number of SSBs associated with the spatial domain filter being on.

11. The UE according to claim 10, wherein, an association of SSB with physical downlink control channel (PDCCH) monitoring occasion for paging is updated at one of the following:
a starting boundary of a nearest PO among a plurality of POs after application of the signaling;
a starting boundary of a nearest paging frame among a plurality of paging frames after application of the signaling; or a starting boundary of a nearest discontinuous reception (DRX) cycle among a plurality of DRX cycles after application of the signaling.

12. The UE according to claim 10, wherein the at least one processor is configured to update an association of SSB with physical downlink control channel (PDCCH) monitoring occasion for paging at a time instance determined by a number of POs indicated in a paging early indication (PEI).

13. The UE according to claim 1, wherein, to determine a paging procedure based on the signaling, the at least one processor is configured to cause the UE to:
in the case of the spatial domain filter being off, not monitor paging early indication (PEI) associated with the spatial domain filter being off.

14. (canceled)

15. (canceled)

16. A processor for wireless communication via a user equipment, the processor configured to:
receive a signaling indicating at least one reference signal (RS), wherein a spatial domain filter associated with the at least one RS is on or off; and
determine at least one of a random access procedure or a paging procedure based on the signaling.

17. The processor of claim 16, wherein, to determine a random access procedure based on the signaling, the processor is configured to not use at least one of the spatial domain filter, a physical uplink shared channel (PUSCH) occasion associated with the spatial domain filter, or a physical random access channel (PRACH) occasion (RO) associated with the spatial domain filter for the random access procedure in the case of the spatial domain filter being off.

18. The processor of claim 16, wherein, in the case that a physical random access channel (PRACH) occasion (RO) associated with the spatial domain filter overlaps a downlink channel or a downlink RS in time domain, the processor is configured to:
receive the downlink channel or the downlink RS in the case of the spatial domain filter being off; or
not receive the downlink channel or the downlink RS in the case of the spatial domain filter being on.

19. The processor of claim 16, wherein, to determine a random access procedure based on the signaling, the processor is configured to:
update synchronization signal (SS)/physical broadcast channel (PBCH) block (SSB) to physical random access channel (PRACH) occasion (RO) association for all or partial ROs based on a set of SSB whose associated spatial domain filter is on.

20. The processor of claim 16, wherein the processor is configured to update the SSB to RO association for all or partial ROs at a start of at least one of an association period, a mapping cycle, or an association pattern period.

21. A method performed by a user equipment (UE), the method comprising:
receiving, at the UE, a signaling indicating at least one reference signal (RS), wherein a spatial domain filter associated with the at least one RS is on or off; and
determining at least one of a random access procedure or a paging procedure based on the signaling.

22. A base station for wireless communication, the base station comprising:
a memory;
at least one receiving circuitry;
at least one transmitting circuitry; and
at least one processor coupled to the memory, the at least one receiving circuitry and the at least one transmitting circuitry, wherein the at least one processor is configured to:
transmit, via the at least one transmitting circuitry, a signaling indicating at least one reference signal (RS), wherein a spatial domain filter associated with the at least one RS is on or off; and
determine at least one of a random access procedure or a paging procedure based on the signaling.
